(19) United States
(12) Patent Application Publication
(10) Pub. No.: US 2016/0147816 A1
(43) Pub. Date: May 26, 2016

(54) SAMPLE SELECTION USING HYBRID CLUSTERING AND EXPOSURE OPTIMIZATION

(71) Applicant: General Electric Company, Schenectady, NY (US)

(72) Inventors: Jerrold Allen Cline, Niskayuna, NY (US); Kete Long, Ridgefield, CT (US); Rui XU, Rexford, NY (US); Zhanpan Zhang, Niskayuna, NY (US)

(21) Appl. No.: 14/550,405

(22) Filed: Nov. 21, 2014

(51) Int. Cl. G06F 17/30; G06Q 10/06

(52) U.S. Cl. CPC G06F 17/30371; G06Q 10/067

(57) ABSTRACT

According to some embodiments, a system includes a communication device operative to communicate with a user to receive a data set including a plurality of samples at a clustering module; a clustering module to receive the data set, store the data set, and calculate one or more clusters of samples using a clustering strategy; an optimization module to receive and store the one or more clusters of samples from the clustering module and generate one or more samples from the one or more clusters of samples using an optimization strategy; a memory for storing program instructions; at least one sample selection platform processor, coupled to the memory, and in communication with the clustering module and the optimization module and operative to execute program instructions to: calculate one or more clusters of samples based on the clustering strategy by executing the clustering module; analyze the data associated with the one or more clusters received from the clustering module using the optimization strategy associated with the optimization module to automatically select one or more samples from the one or more clusters; and provide one or more samples generated by the optimization module for replication in a validation model. Numerous other aspects are provided.

### BACKGROUND

Clustering is a known technique to explore natural and hidden data structures. More specifically, clustering is the task of grouping a set of objects in such a way that objects in the same group (clusters) are more similar (in some sense or another) to each other than to those objects in other groups (clusters). A cluster is a set of data objects that are similar to each other, while data objects in different clusters are different from one another. A cluster may typically be a continuous region of data objects with a relatively high density, which is separated from other such dense regions by low-density regions.

Modeling is the task of building an abstract representation of a real world situation that may be used to help explain a system, to study the effects of different components, and/or to make predictions about behavior. For example, financial modeling is the task of building an abstract representation of real world financial situations that may be used to value financial instruments. Frequently, after a model is built, it is tested or validated. Typically modeling may involve a large amount of data samples (e.g., 30K transactions in financial models), and when validating a model, replicating all of the data samples is usually too time consuming As such, a subset of samples is usually selected to replicate in the validation/testing. Even with sample selection (subset of samples), it is desirable to use the fewest samples that is reasonable to increase validation efficiency. Conventionally, sample selection is done through manual selection from a list, which may be time consuming and result in sample bias.

Therefore, it would be desirable to design an apparatus and method that provides for a quicker, rigorous, and more effective way to perform sample selection.

### BRIEF DESCRIPTION

According to some embodiments, a sample subset is selected from a data set of samples by the application of a clustering module and an optimization model. The clustering module is applied to data associated with user-selected variables to generate one or more clusters, and then the optimization module is applied to the data associated with the clusters to generate the sample subset.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

A technical effect of some embodiments of the invention is an improved technique and system for sample selection. With this and other advantages and features that will become hereinafter apparent, a more complete understanding of the nature of the invention can be obtained by referring to the following detailed description and to the drawings appended hereto.

Other embodiments are associated with systems and/or computer-readable medium storing instructions to perform any of the methods described herein.

### DRAWINGS

FIG. 1 illustrates a system according to some embodiments.

FIG. 2 is a flow diagram according to some embodiments.

FIG. 3 illustrates a data set according to some embodiments.

FIG. 4 illustrates a user interface according to some embodiments.

FIG. 5 illustrates a user interface according to some embodiments.

FIG. 6 illustrates a user interface according to some embodiments.

FIG. 7 illustrates a user interface according to some embodiments.

FIG. 8 is a block diagram of a sample selection processing tool or platform according to some embodiments.

FIG. 9 is a flow diagram according to some embodiments.

FIG. 10 illustrates a user interface according to some embodiments.

FIG. 11 illustrates a user interface according to some embodiments.

FIG. 12 illustrates a user interface according to some embodiments.

FIG. 13 illustrates a user interface according to some embodiments.

FIG. 14 is a flow diagram according to some embodiments.

FIG. 15 illustrates a user interface according to some embodiments.

FIG. 16 illustrates a user interface according to some embodiments.

FIG. 17 illustrates a user interface according to some embodiments.

FIG. 18 illustrates a user interface according to some embodiments

### DETAILED DESCRIPTION

Typically after a model is built to help explain a system, to study the effects of different components and/or to make predictions about behavior, the model is tested or validated with a validation model. Often the model may involve a large amount of data samples, and it is undesirable to test all of the data samples in the validation model as it is too time consuming. As such, a subset of samples from the data set are often selected for testing in the validation model. Conventionally, the subset of samples are selected manually, in a time consuming and possibly biased process. It is desirable to select the fewest number of samples that is reasonable to increase validation efficiency and that meets the needs of sample diversity and exposure coverage/risk metrics.

Some embodiments may include the application of clustering strategies (both numerical and categorical) via a clustering module to data associated with user-selected variables to group similar data objects together, and thereby provide sample diversity between the clusters, and then the application of optimization strategies via an optimization module to the identified clusters to select the samples from the clusters that best meet user objectives (e.g., coverage goals in terms of exposure or risk metrics of the selected samples relative to all samples in the financial fields). In one or more embodiments, exposure may be the amount of risk one is exposed to in the investment. For example, if the data being modeled is that of a loan, the exposure may be the dollar amount of the loan as there is a chance the whole amount is defaulted on and thus lost. However, other risk metrics besides dollar exposure, related to various financial instruments may be included. As such, one or more embodiments include multiple exposure and risk metrics as coverage objectives. While the example data and objectives used herein are financial in nature, embodiments of the invention are applicable to data in other fields.

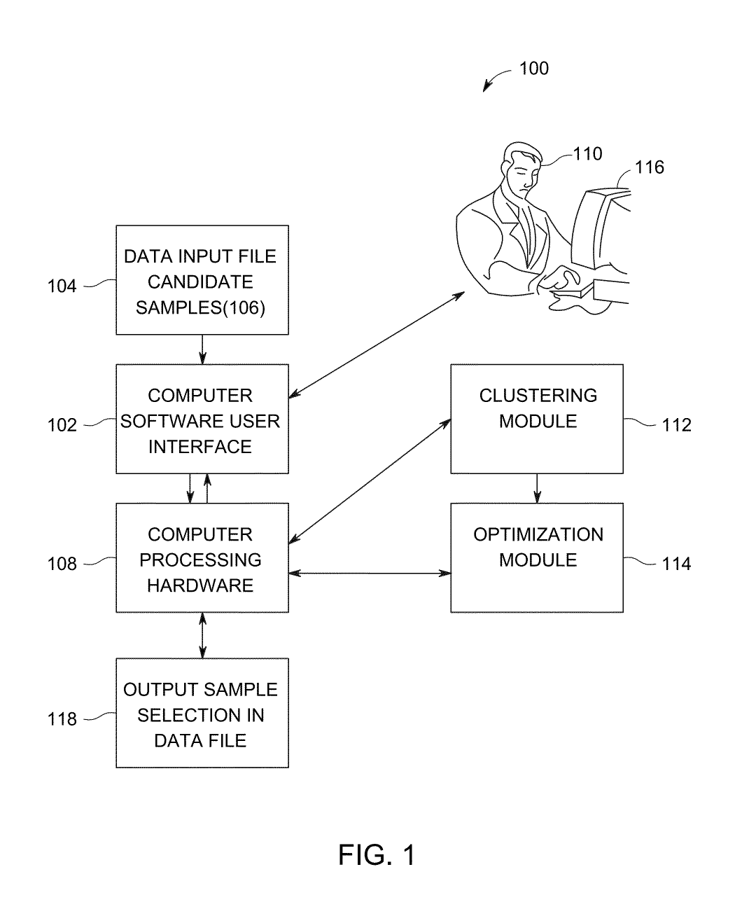

FIG. 1 is an example of a sample selection system 100 according to some embodiments. The system 100 may include a computer software interface 102, one or more data input files 104 including a plurality of candidate samples 106, computer processing hardware 108, a user 110, a clustering module 112, an optimization module 114, a display 116 displaying the sample selection, for example, and an output file 118 including the sample selection.

As will be further described below, the computer software interface 102 may receive one or more data input files 104 including a plurality of candidate samples 106. The candidate samples 106 may be the data set from which the samples are selected via application of the clustering module 112 and the optimization module 114, in one or more embodiments. In some embodiments, the data set includes a plurality of variables associated with each sample. A subset of the plurality of variables may be user-selected through the computer software interface 102, and the clustering module 112 and optimization module 114 applied to these user-selected variables. The clustering module 112 may interact with the user 110 via the computer processing hardware 108 and computer software user interface 102 to capture information from the user 110 regarding the clustering of selected variables (e.g., type of clustering strategy to apply, number of clusters, etc.). The clustering module 112 may determine a number of clusters in one or more embodiments, and provide the cluster information to the optimization module 114. The optimization module 114 may interact with the user 110 via the computer processing hardware 108 and computer software user interface 102 to capture information from the user 110 regarding optimization of the clusters (e.g., type of optimization strategy to apply, etc.). The optimization module 114 may select the samples and output them in a data file 118 via the computer processing hardware 108. These selected samples may also be displayed to the user 110 at display 116, via the computer processing hardware 108 and the computer software user interface 102.

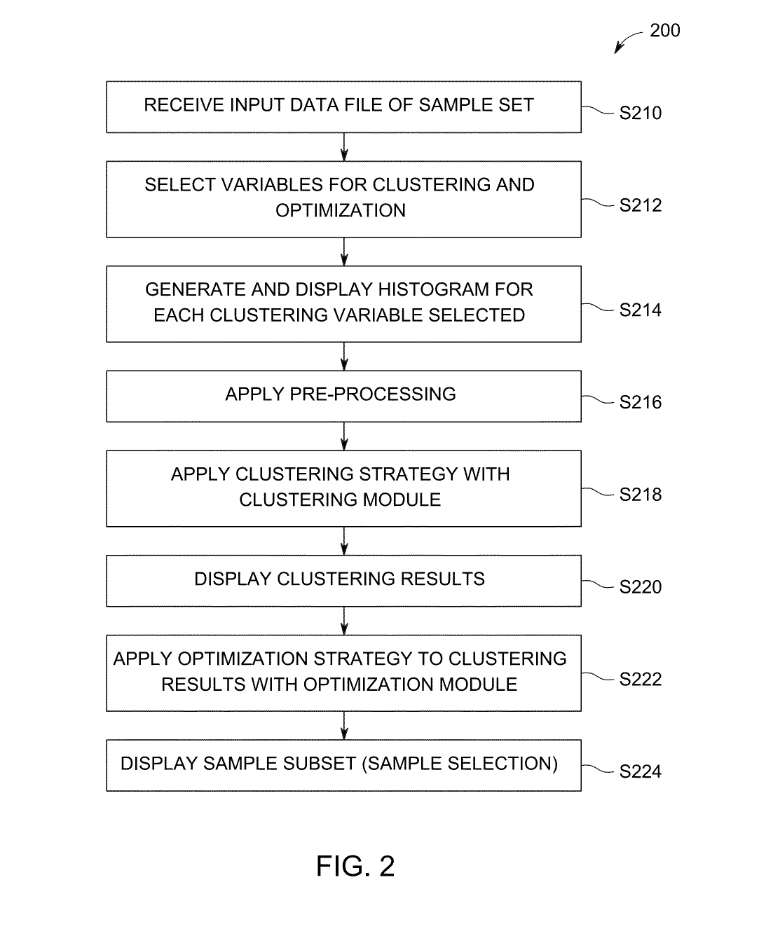

Turning to FIGS. 2-7, in one example of operation according to some embodiments, FIG. 2 is a flow diagram of a process 200 according to some embodiments. Process 200 and the other processes described herein may be performed using any suitable combination of hardware (e.g., circuit(s)), software or manual means. In one or more embodiments, the system 100 is conditioned to perform the process 200, such that the system 100 is a special purpose element configured to perform operations not performable by a general purpose computer or device. Software embodying these processes may be stored by any non-transitory tangible medium including a fixed disk, a floppy disk, a CD, a DVD, a Flash drive, or a magnetic tape. Examples of these processes will be described below with respect to the elements of the system 100, but embodiments are not limited thereto.

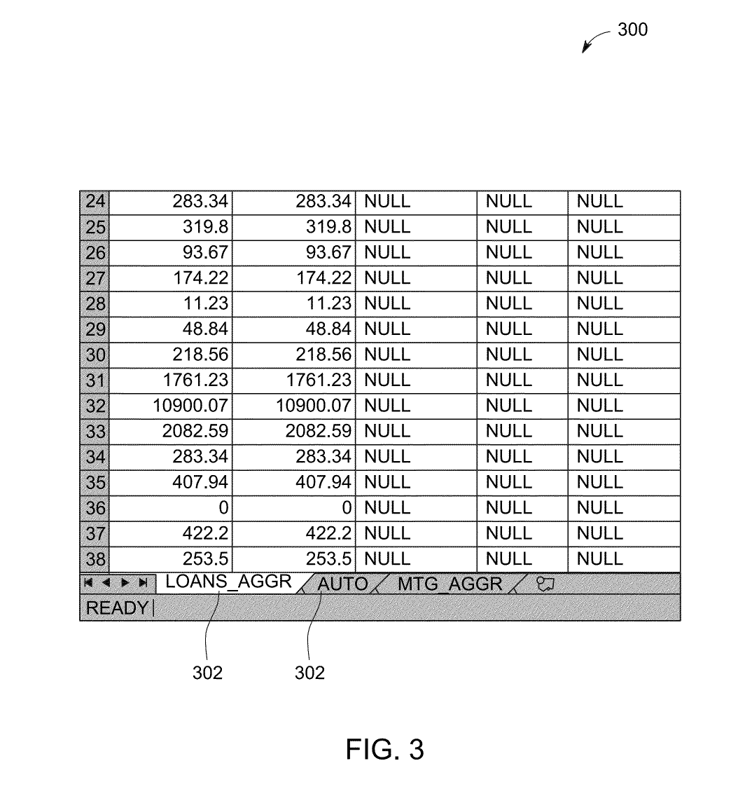

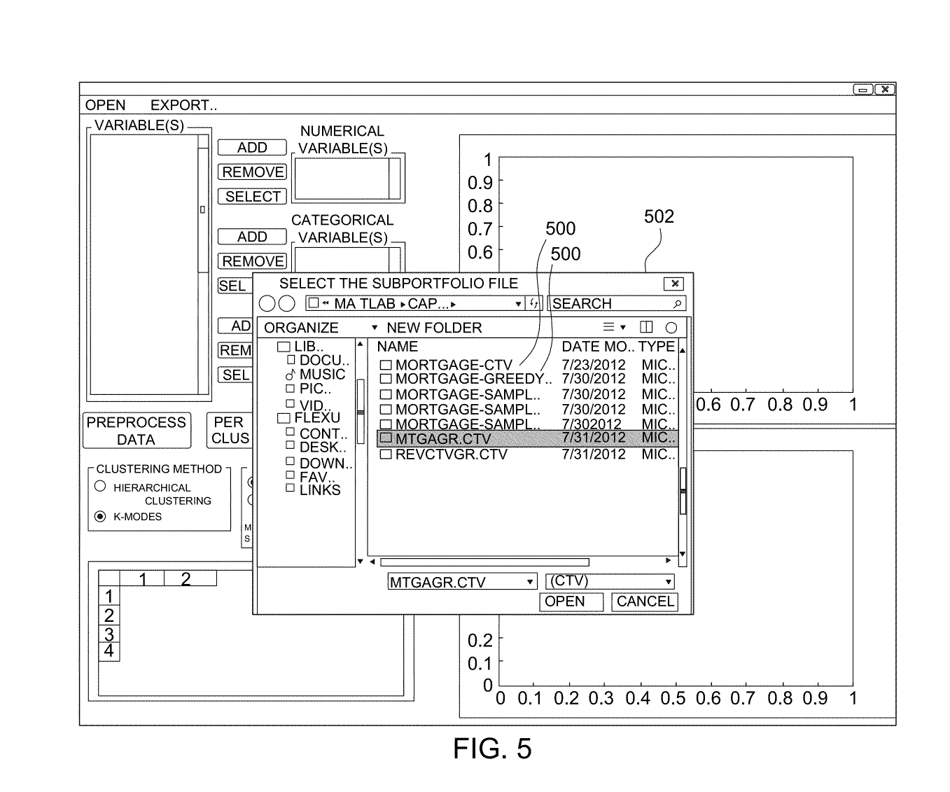

Initially, at S210, a data file 500 (FIG. 5) including a sample set of data 300 (FIG. 3) is received as input. The data may be, for example, in a spreadsheet including multiple tabs 302 of data. The data may be listed such that each row includes all of the data for a particular data sample, and each column represents a different variable associated with a particular data sample. Other suitable expressions of data may be used. In one or more embodiments, the process 200 may be performed for one tab 302 at a time, and thereby select samples from one tab, based on identified criteria, for each iteration of the process 200.

In one or more embodiments, a comma-separated-value (csv) file may be generated for each tab. When using csv files, the comma is used as a separator for each column, therefore if a comma exists in the data, the data may not be read correctly. As such, in one or more embodiments, a user may remove any commas from the data. For example, the user may delete the commas, replace the commas with some other symbols, or change the number format.

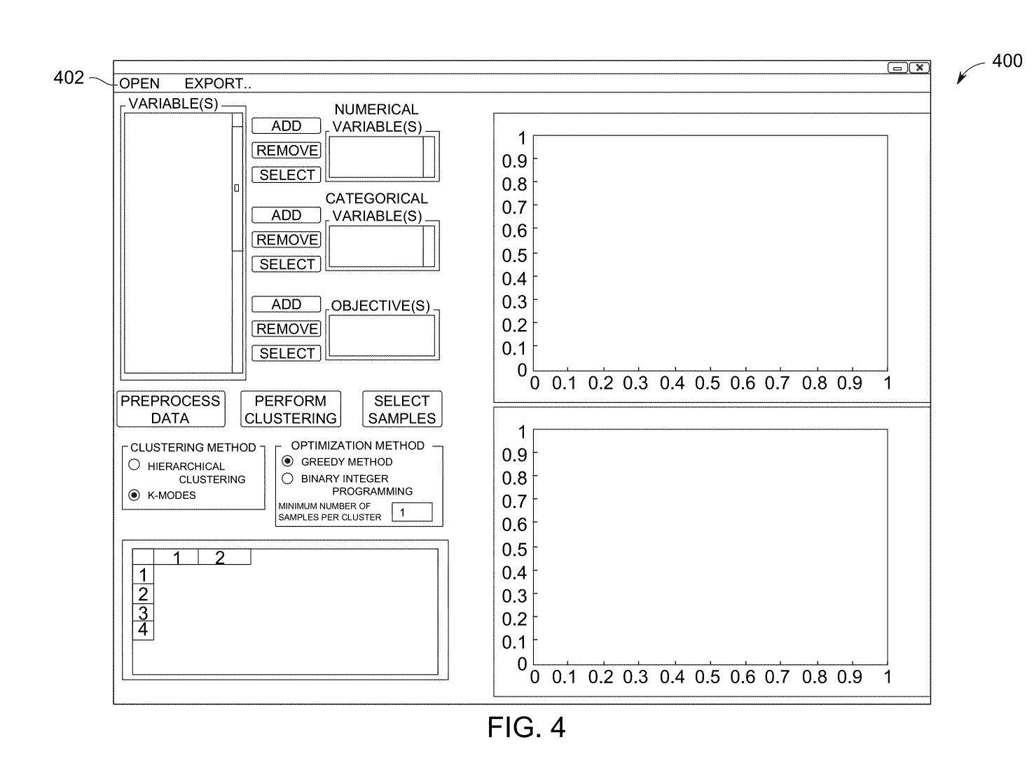

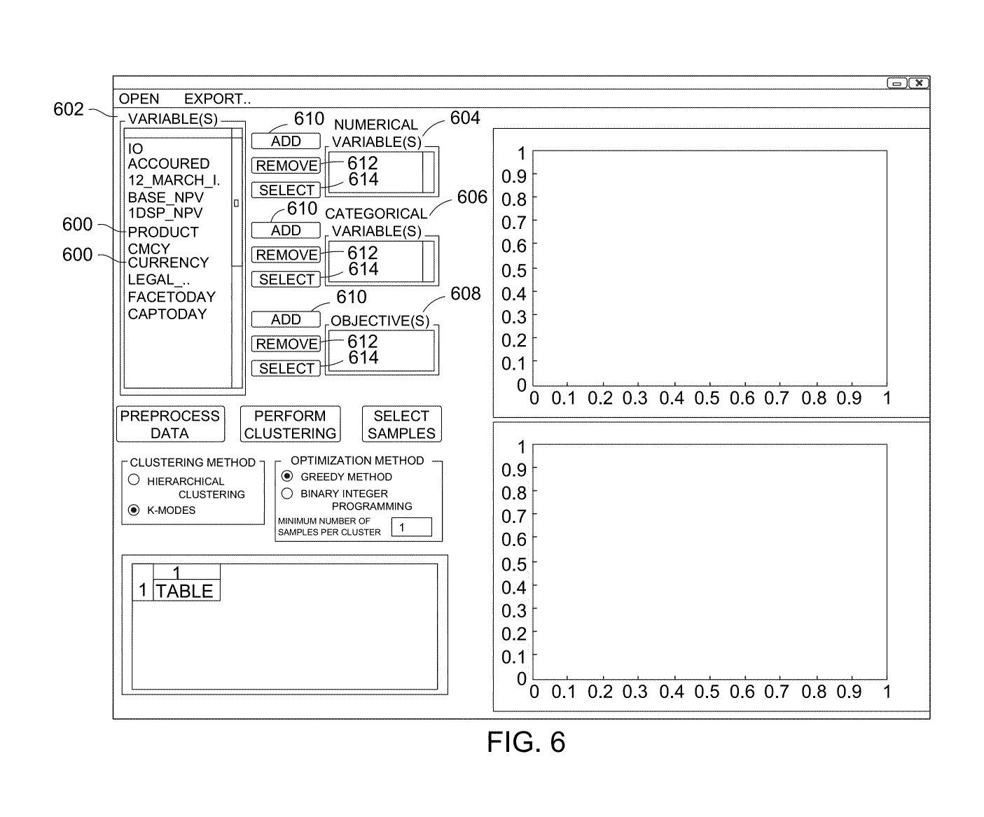

Turning back to S210, the user may be presented with a user interface 400 (FIG. 4) on display 116. To input the data 300 from the data file 500 into the system 100, the user may select an open menu 402, which generates a dialog box 502 (FIG. 5) showing one or more data file(s) 500. The user may select the data file 500 from which to select samples, and open it. In one or more embodiments, opening the data file 500 inputs one or more variables 600 associated with each data sample from the data file 500 into the variable window 602 (FIG. 6).

Then in S212, variables 600 for clustering and optimization are selected. The variables 600 for clustering may be either numerical variables or categorical variables. In one or more embodiments, numerical variables are data fields expressed as numerical data (e.g., days to maturity date, coupon today), and categorical variables are data fields expressed as descriptive data (e.g., type of currency, accrual code, amortization code). The optimization variables may be described as objectives related to the optimization. For example, the objectives may be associated with risk metrics (e.g., select samples so that the clusters are sufficiently represented, while using as few samples as possible) and coverage (e.g., cover 20% of a dollar amount of a whole portfolio). For example, the coverage objectives may be dollar exposure (which may be the nominal dollar amount of the position) and DV01 may be defined as the change in investment value for a 0.01% change in interest rates.

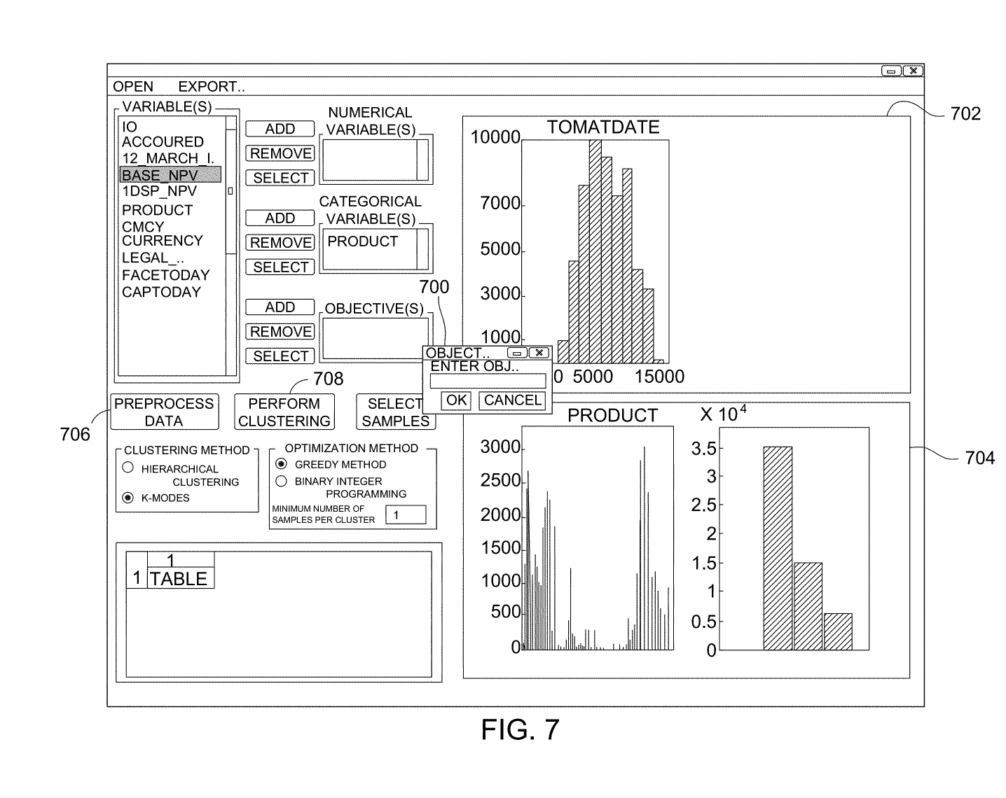

The user may, in one or more embodiments, select a variable from window 602 and move it into numerical variable window 604, categorical variable window 606, or objective window 608 by highlighting the variable 600 and then selecting the add button 610 aligned with the appropriate variable window 604, 606 and 608. While add/remove buttons 610/612 are shown herein for moving and removing, respectively, the variables 600 to/from the variable windows 604, 606, and 608, other suitable selection means may be used. For example, a drag-and-drop method may be used to select variables. In one or more embodiments, the user may select only numerical variables or categorical variables. After adding an objective variable to objective variable window 608, the user may be prompted, in one or more embodiments, via an objective input dialog box 700 (FIG. 7) to enter a target value for the selected objective variable. In one or more embodiments, the objective input dialog box 700 may include a default value of 0.2, or other suitable default value, that the user may change. In one or more embodiments, the target value is in the range (0,1]. For example, if objectives Base-NPV and BalToday are selected, and the target is set for each objective to 0.2, then for each objective/goal, the selected samples should have at least 20% exposure in terms of both objective variables.

In one or more embodiments, after the user has selected the variables such that they are listed in the appropriate variable windows, the user may select the select button 614 to confirm the selection. In one or more embodiments, a message box (not shown) may appear after selection of the select button 614 to confirm the variables are successfully selected.

Then in S214, a histogram is generated for the clustering variables and displayed in the histogram for numerical values window 702, and the histogram for categorical variables window 704 for each of the selected numerical and categorical variables, respectively. In one or more embodiments, the histograms may be generated and displayed after the confirmation of the selection of the clustering variables prior to selection of the objective variables. The histograms may provide a visualization of how the data is spread prior to application of the clustering module 112 and the optimization module 114 to facilitate a user's evaluation of the sample selection.

In S216, preprocessing is applied to the data via user selection of the preprocessing button 706 (FIG. 7). During preprocessing, the data may be evaluated to determine whether there are missing values for selected variables. In one or more embodiments, if the data associated with the selected variable is missing a value, it may be eliminated from the further steps. During preprocessing, the data values of the categorical variables that are characters may be converted into integers. In one or more embodiments, the clustering module 112 processes integers, and conversion of the characters in the categorical variables into integers may facilitate the application of the clustering module 112.

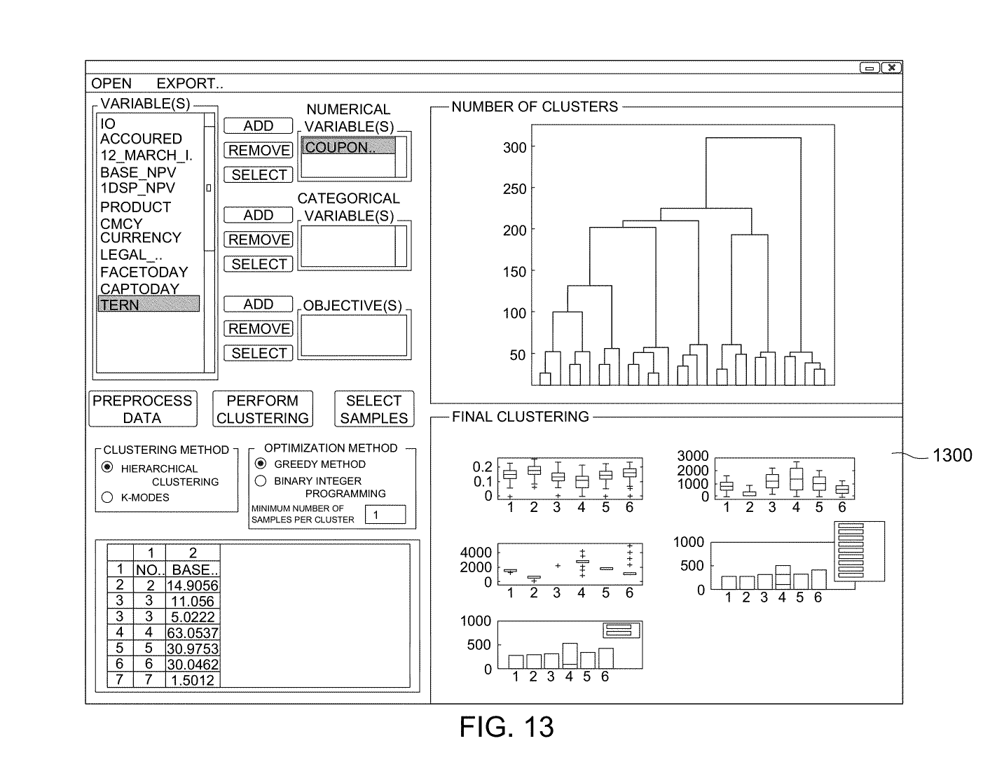

Then in S218 the clustering module 112 is applied via selection of the “perform clustering” button 708 (FIG. 7), as will be further described below. Generally, for each selected clustering variable, the task of clustering groups the data in the those variables into groups or clusters where the data in each cluster is similar to each other in some manner compared to data in a different cluster. The resulting clusters are displayed in a final clustering window 1300 (FIG. 13) in S220.

After the clusters are selected, the samples may be selected from these clusters by the application of the optimization module 114 to these clusters in S222 via selection of an optimization strategy, as will be further described below.

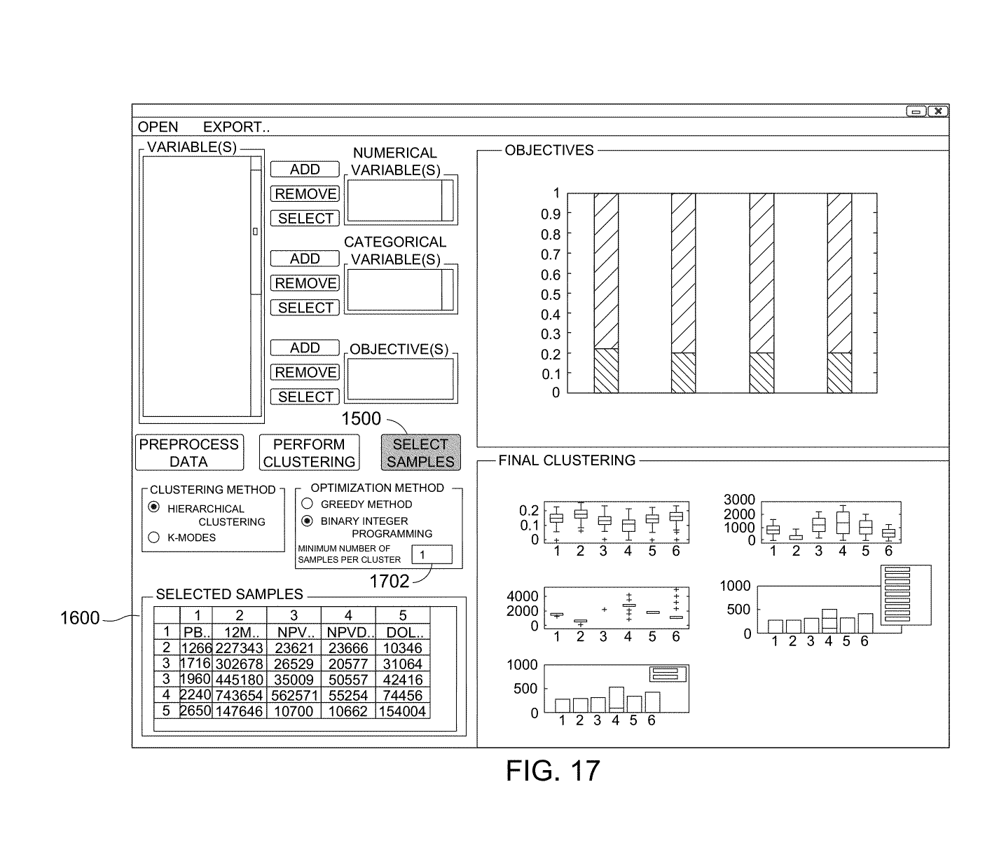

The resulting samples may be displayed (FIG. 17) in S224.

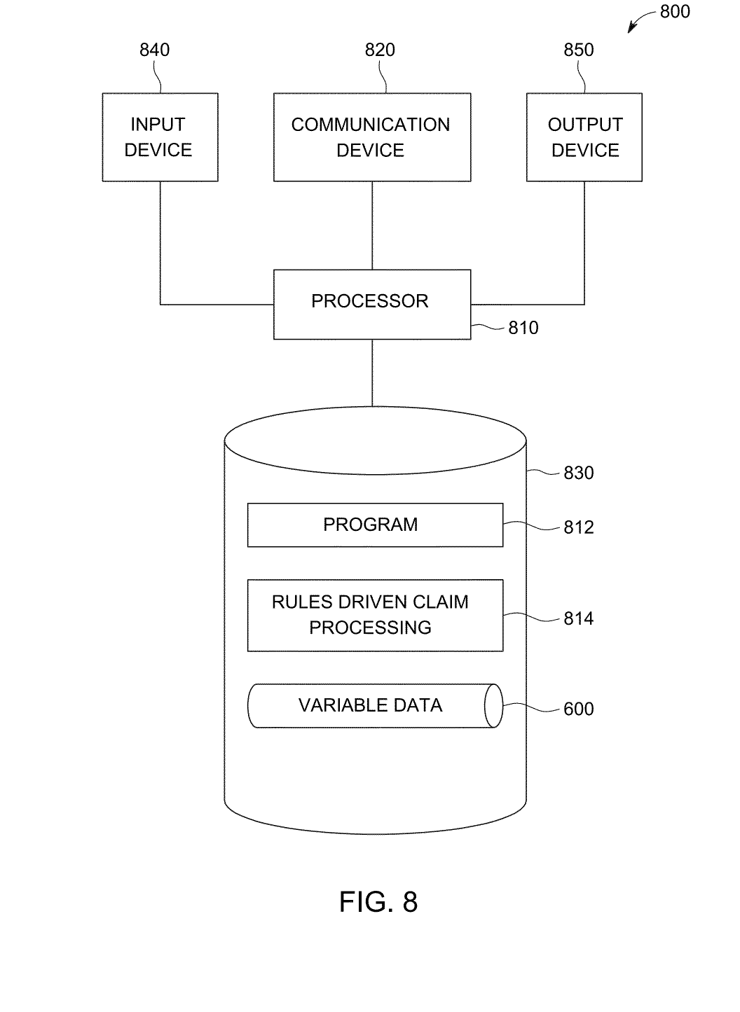

Note the embodiments described herein may be implemented using any number of different hardware configurations. For example, FIG. 8 illustrates a sample selection processing platform 800 that may be, for example, associated with the system 100 of FIG. 1. The sample selection processing platform 800 comprises a sample selection platform processor 810, such as one or more commercially available Central Processing Units (CPUs) in the form of one-chip microprocessors, coupled to a communication device 820 configured to communicate via a communication network (not shown in FIG. 8). The communication device 820 may be used to communicate, for example, with one or more users. The sample selection processing platform 800 further includes an input device 840 (e.g., a mouse and/or keyboard to enter information about variables, clustering and optimization) and an output device 850 (e.g., to output and display the selected samples).

The processor 810 also communicates with a storage device 830. The storage device 830 may comprise any appropriate information storage device, including combinations of magnetic storage devices (e.g., a hard disk drive), optical storage devices, mobile telephones, and/or semiconductor memory devices. The storage device 830 may store a program 812 and/or sample selection processing logic 814 for controlling the processor 810. The processor 810 performs instructions of the programs 812, 814, and thereby operates in accordance with any of the embodiments described herein. For example, the processor 810 may receive variable data and then may apply the clustering module 112 and then the optimization module via the instructions of the programs 812, 814 to select one or more samples.

The programs 812, 814 may be stored in a compressed, uncompiled and/or encrypted format. The programs 812, 814 may furthermore include other program elements, such as an operating system, a database management system, and/or device drivers used by the processor 810 to interface with peripheral devices.

As used herein, information may be “received” by or “transmitted” to, for example: (i) the platform 800 from another device; or (ii) a software application or module within the platform 800 from another software application, module, or any other source.

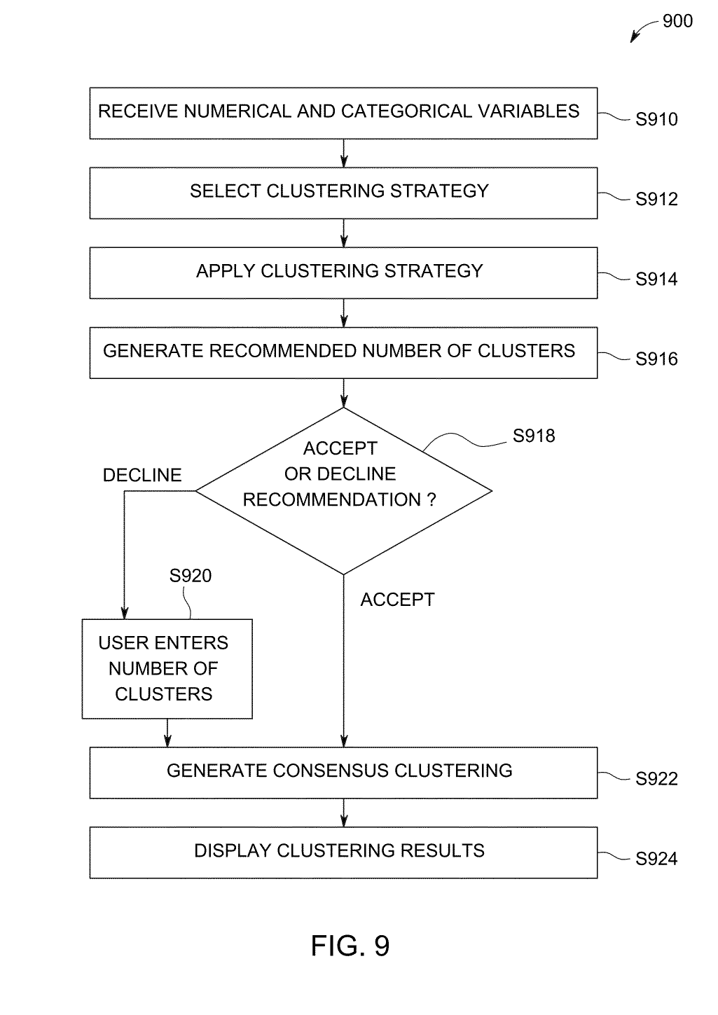

Turning to FIGS. 9-13, in one example of operation according to some embodiments, FIG. 9 is a flow diagram of a process 900 performed by the clustering module 112. The process 900 may be associated with the application of a clustering strategy selected in S218 to clustering variables according to some embodiments. In one or more embodiments, the clustering may be based on an ensemble of clustering results (“consensus clustering”), where clustering is applied to the variables multiple times. For example, in one or more embodiments, clustering may be applied to each of the numerical and categorical variables 50 times. The clustering module 112 may then combine these results to generate the final consensus clustering. In one or more embodiments, clustering ensembles, may combine multiple partitions for a set of data by 1. Applying different clustering strategies multiple times, 2. Applying the same strategy multiple times but with different parameters or with a random initialization may be superior to individual base clustering strategies for discovering complicated and noisy data structures. In one or more embodiments, clustering ensembles may need a sufficient number (e.g., 50 or more) of individual base clustering runs. A number of known clustering strategies are developed for either numerical or categorical variables only and they may not be applied to data with mixed data types (e.g., both numerical and categorical variables). In one or more embodiments, the data is divided into numerical variable only subsets and categorical variable only subsets, and the corresponding clustering strategy is applied to each subset multiple times, and then a consensus clustering from the multiple runs is obtained, as described further below. Inventors note that this method takes advantage of the clustering ensembles approach and overcomes the limitations of many clustering strategies on mixed data types, as embodiments of the invention may use any clustering strategy that is designed for numerical variables to cluster numerical variable-based subsets and may use any clustering strategy for categorical variables to cluster categorical variable-based subsets. In one or more embodiments, the base clustering strategy may be K-means and K-modes, as they have a relatively low time complexity and easy implementation, as will be further described below.

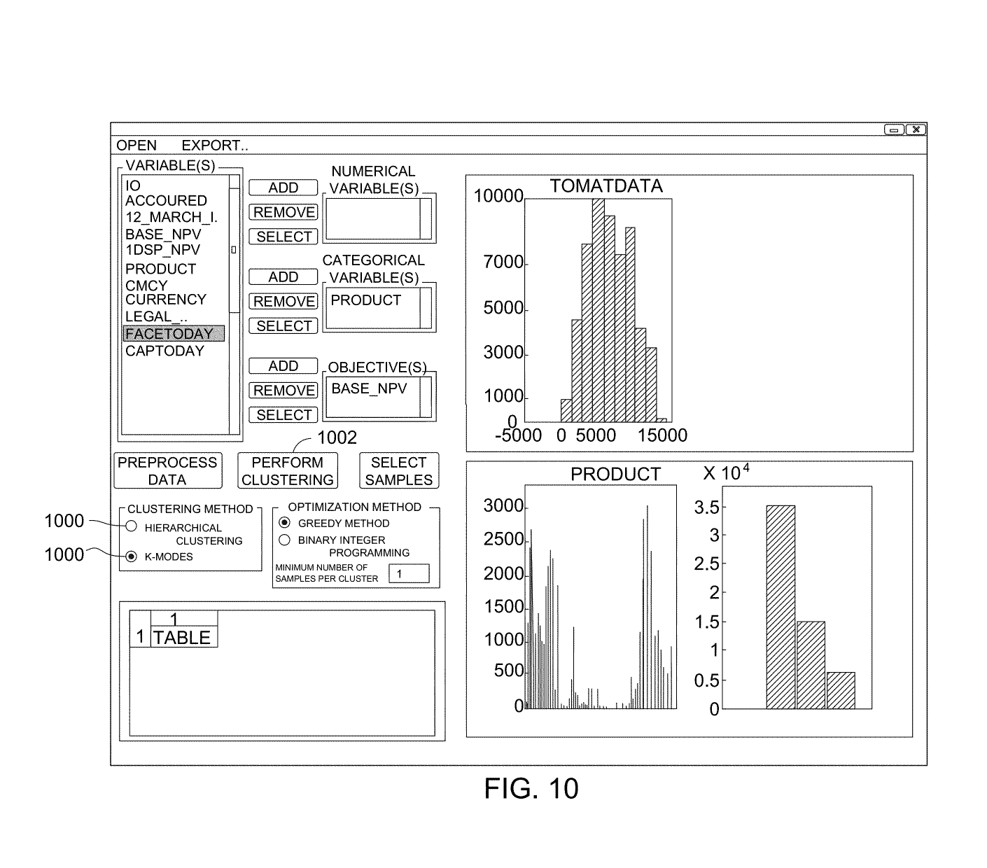

Initially at S910, the clustering module 112 receives the selected categorical and numerical variables. A clustering strategy is selected by the user in S912, via selection of a clustering method button 1000 (FIG. 10). In one or more embodiments, the clustering strategy is one of a hierarchical clustering strategy and a K-mode clustering strategy. In one or more embodiments, when a data set is small, applying a hierarchical clustering strategy may produce resulting clusters in less time than a K-mode clustering strategy, for example, and may provide good visualization of the clusters. However, if the data set is large (e.g., 10K), the hierarchical clustering strategy may take a long time to produce resulting clusters. As such, in one or more embodiments, if the data set is large (e.g., more than 5000 data elements), the user may be notified and the K-mode clustering strategy automatically selected. In one or more embodiments, the K-modes based clustering strategy may take longer than the hierarchical clustering strategy for a small data set, but may be more appropriate for larger data sets.

In one or more embodiments, for both the hierarchical clustering strategy and the “K-modes” clustering strategy, a K-means clustering process may be used to cluster numerical data associated with numerical variables, while a K-modes clustering process may be used to cluster categorical data associated with categorical variables. Note the “K-modes” clustering process is the counterpart of the K-means clustering process for the data with categorical variables. For the “K-mode” clustering strategy, in one or more embodiments, each clustering result from individual base clustering may be considered as a new variable. Because the clustering result contains a set of clustering labels (e.g., 1-6 if the number of clusters is 6), such a variable is a categorical variable. In some embodiments, after the clustering ensemble step, the data may include a set of samples, with each sample corresponding to a set of clustering labels (or variables). The K-mode clustering process may be used again, in one or more embodiments, to get the final consensus clustering, but other suitable clustering processes for categorical variables may also be applied.

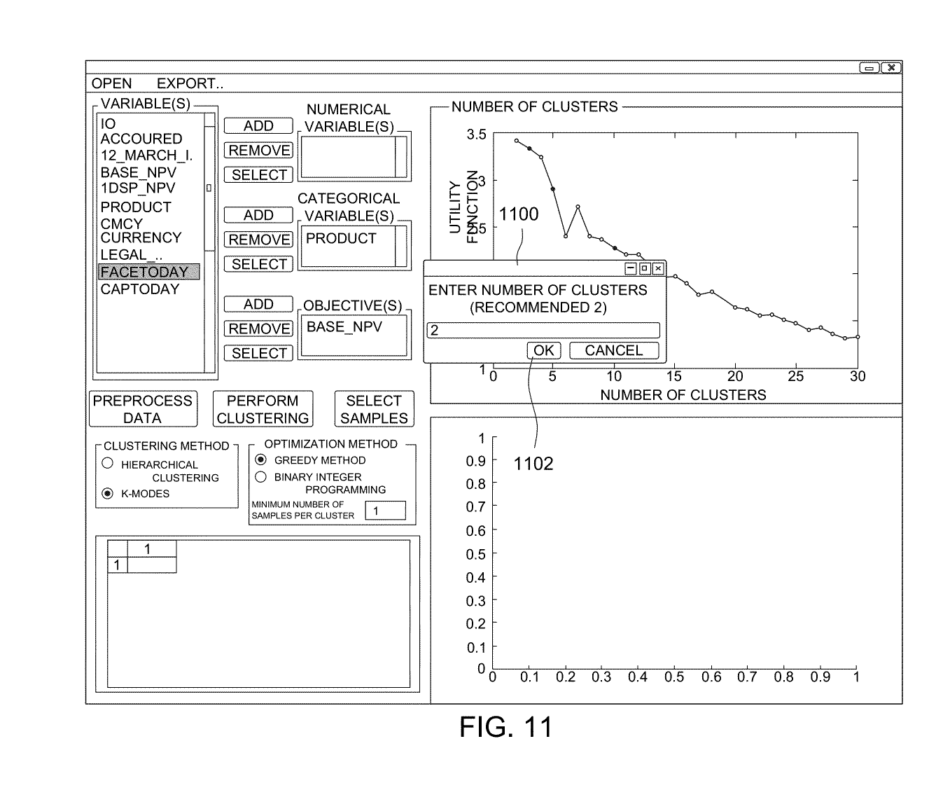

In S914, the clustering strategy is applied via user selection of a “Perform Clustering” button 1002 (FIG. 10). In one or more embodiments, the clustering module 112 may estimate the number of clusters in the data. In one or more embodiments, the clustering module 112 makes this estimation based on category utility function when the K-mode strategy is selected, and clustering lifetime when the hierarchical strategy is selected. The clustering module 112 generates a recommended number of clusters in S916, and displays this recommendation in a cluster input dialog box 1100 (FIG. 11). In S918, a user may decide to accept or decline the recommended number of clusters. If the user declines the recommendation, the user may overwrite the recommended number of clusters, and enter a different number in the cluster input dialog box 1100 in S920. For example, the clustering module 112 may recommend 2 clusters, but a user may want a finer partition of the data, and may enter 20 clusters, for example. The user may select the number of clusters via selection of the “OK” button 1102 in the cluster input dialog box 1100. Then, the clustering module 112 may use that number to generate the final consensus clustering in S922. After the clustering is complete, the clustering results are displayed in S924, as shown in the final clustering window 1300 in FIG. 13. In one or more embodiments, a boxplot displays clusters associated with numerical variables, and a bar plot displays clusters associated with categorical variables.

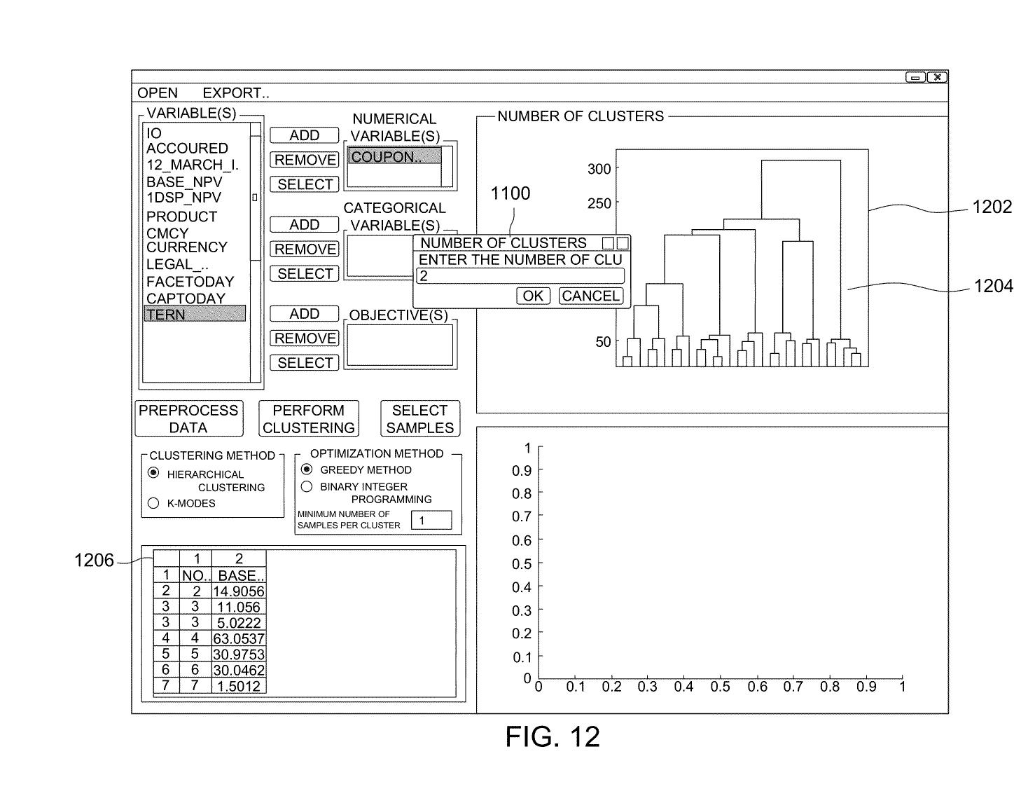

For the clustering results displayed in FIG. 13, for example, the hierarchical clustering strategy was selected, and the recommended number of clusters (2) was accepted. In one or more embodiments, hierarchical clustering may include at least one of single linkage clustering (nearest neighbor), where D_{SL}(X,Y)=min_{i∈X,j∈Y} D(ij), complete linkage (farthest neighbor), where D_{CL}(X,Y)=max_{i∈X,j∈Y} D(i,j), group average linkage (the unweighted pair group method average), where D_{AL}(X,Y)=avg_{i∈X,j∈Y} D(i,j), and the centroid linkage (the unweighted pair group method centroid), where D_{CTL}(X,Y)=D(avg(X), avg(Y)). In one or more embodiments, when the hierarchical clustering strategy is selected, the clustering results associated with the recommended number of clusters may be displayed as a dendrogram in the clustering dendrogram window 1202 (FIG. 12) to provide a visual indication of how the samples are clustered. In one or more embodiments, hierarchical clustering may have different linkage definitions (e.g., criterion determining the distance between sets of observations). For example, the linkage definition used herein is Ward's method (also called minimum variance method). In one or more embodiments, the goal of hierarchical clustering is to minimize the increase of within-cluster sum of the squared errors. In one or more embodiments the linkage definition may be chosen based on the data. In one or more embodiments, at most 30 leaf nodes may be shown in the plot. Other suitable numbers of nodes may be shown. In one or more embodiments, if there are more than 30 samples, for example, the dendrogram may collapse lower branches to make 30 leaf nodes. In one or more embodiments, the height of the U-shaped lines in the dendrograms 1204 represent the distance between a pair of clusters being connected. In one or more embodiments, the cluster lifetime window 1206 displays the range of threshold values on the dendrogram that lead to the identification of a certain number of clusters. In one or more embodiments, the recommended number of clusters may correspond to the longest lifetime. In one or more embodiments, K-cluster lifetime may be the range of threshold values on the dendrogram that may lead to the identification of k clusters. In one or more embodiments, the lifetime may be the increase of distance on the dendrogram if two clusters are merged to generate a new cluster. For example, in one or more embodiments, the lifetime may be the numeric representation of a penalty for combining the last two clusters into one cluster (e.g., the distance from the hierarchical dendrogram), whereby if the penalty (lifetime) is too big, it may not be desirable to merge the two clusters into one new cluster. For the example shown herein, the number of clusters (2) corresponds to 87.3985, which is the longest lifetime. In one or more embodiments, after viewing the results associated with the recommended number of clusters in the cluster lifetime window 1206, the user may enter a different number for the number of clusters in the cluster input dialog box 1100. For example, the user may enter 6 in the cluster input dialog box 1100 after viewing the cluster lifetime for 6 clusters is 63.0537, the second largest cluster lifetime. The final clustering results for 6 clusters are shown in the final clustering window 1300 in FIG. 13.

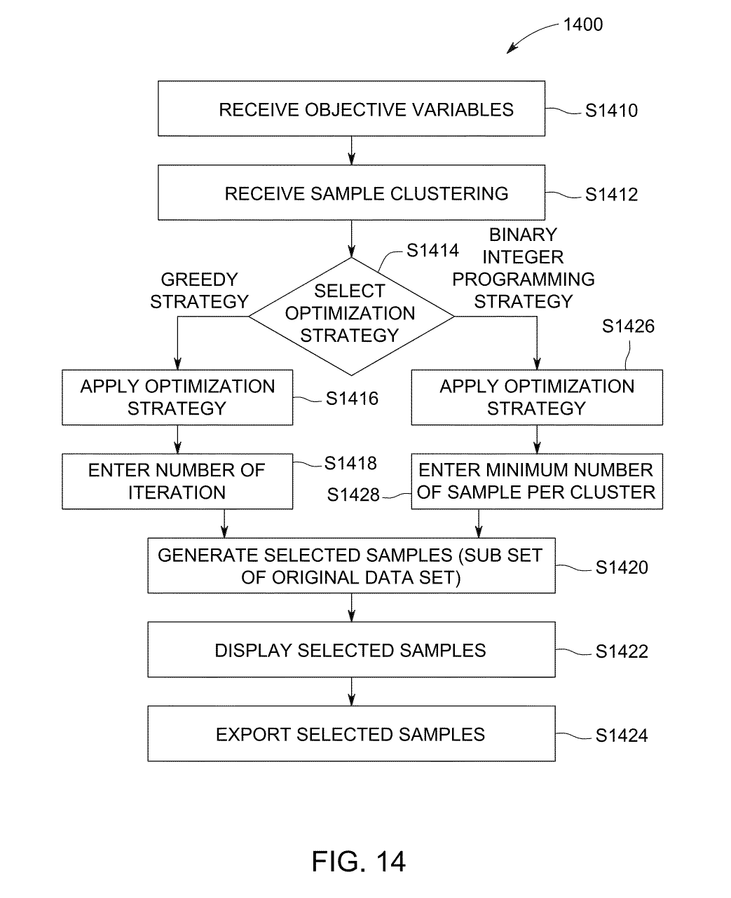

In one or more embodiments, the optimization module 114 is applied to the output (final clustering) of the clustering module 112. The optimization module 114 may apply one of two optimization strategies: a greedy optimization strategy and a binary integer programming optimization strategy. Turning to FIGS. 14-18, in one example of operation according to some embodiments, FIG. 14 is a flow diagram of a process 1400 performed by the optimization module 114 on the resulting final clusters generated by the clustering module 112 to select the samples.

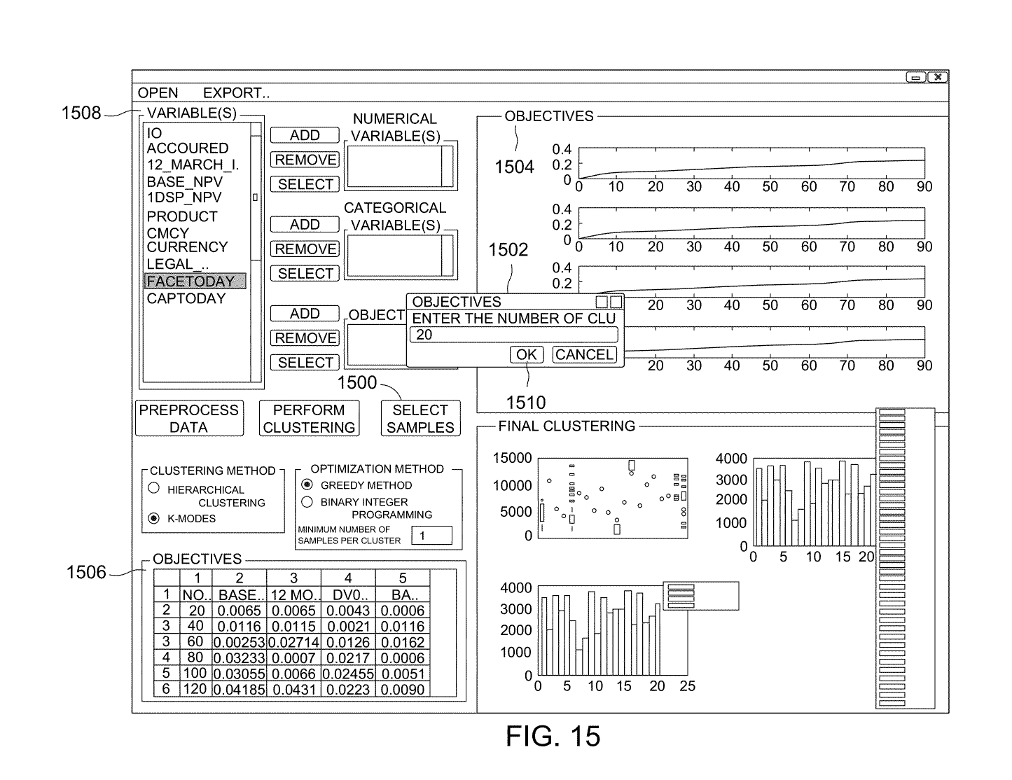

Initially at S1410 the selected objective variables are received at the optimization module 114. For each objective variable, the optimization module 114 may rank the samples within each cluster in an ascending order, in one or more embodiments. Then in S1412, the clustering results from the clustering module 112 are received at the optimization module 114. The user selects the optimization strategy in S1414. If the user selects the greedy optimization strategy, the process 1400 proceeds to S1416, and the strategy is applied, via user selection of a “Select Samples” button 1500 (FIG. 15).

Using the greedy optimization strategy, for each objective variable, the optimization module 114 may rank the samples within each cluster in an ascending order based on different objectives, in one or more embodiments. In other embodiments, the samples may be ranked in descending order. For example, in FIG. 15, where four variables are selected in the Objective variable window 608, each sample will have four ranks (one associated with each variable) within the cluster it belongs to. The overall rank of the sample may be the sum of the four ranks. Using the greedy optimization strategy, the optimization module 114 may select samples based on the overall rank. In one or more embodiments, the samples with the lowest overall rank are selected. In other embodiments, samples with the highest or other ranks are selected. For each iteration, the greedy optimization strategy will select one sample from each cluster, which has the lowest overall rank in its cluster and is not selected yet. This process may iterate until the identified targets for all objective variables are reached, in one or more embodiments. After the first iteration of the greedy optimization strategy, the optimization module 114 may recommend a number of iterations for the module to run to select the samples, and prompt the user to enter a number of iterations in the iteration dialog box 1502 (FIG. 15) in S1418. In one or more embodiments, the user may accept the recommended number of iterations, or may select a different number of iterations. In one or more embodiments, the recommended value may be the value that meets the targets for all objectives. In the example shown in FIG. 15, the optimization module 114 recommends 90 iterations, which will lead to 90*20=1800 samples selected, if 20 clusters were used. While the iteration dialog box 1502 is open, an objectives chart window 1504 may display charts showing the relation between the exposure and the number of selected samples for all objectives. In one or more embodiments the information displayed in the objective chart window 1504 may also be displayed in table form in an objectives table window 1506. For example, Row 6 in the objective table window 1506 says that with 100 samples selected, the exposure for Base NPV is about 3.23%, the exposure for 12_Month_In is about 3.07%, the exposure for DV01 is about 2.49%, and the exposure for BalToday is about 2.51%. In one or more embodiments, the data in the objectives table window 1506 may be exported/transmitted to a file by selecting the “export” menu 1508.

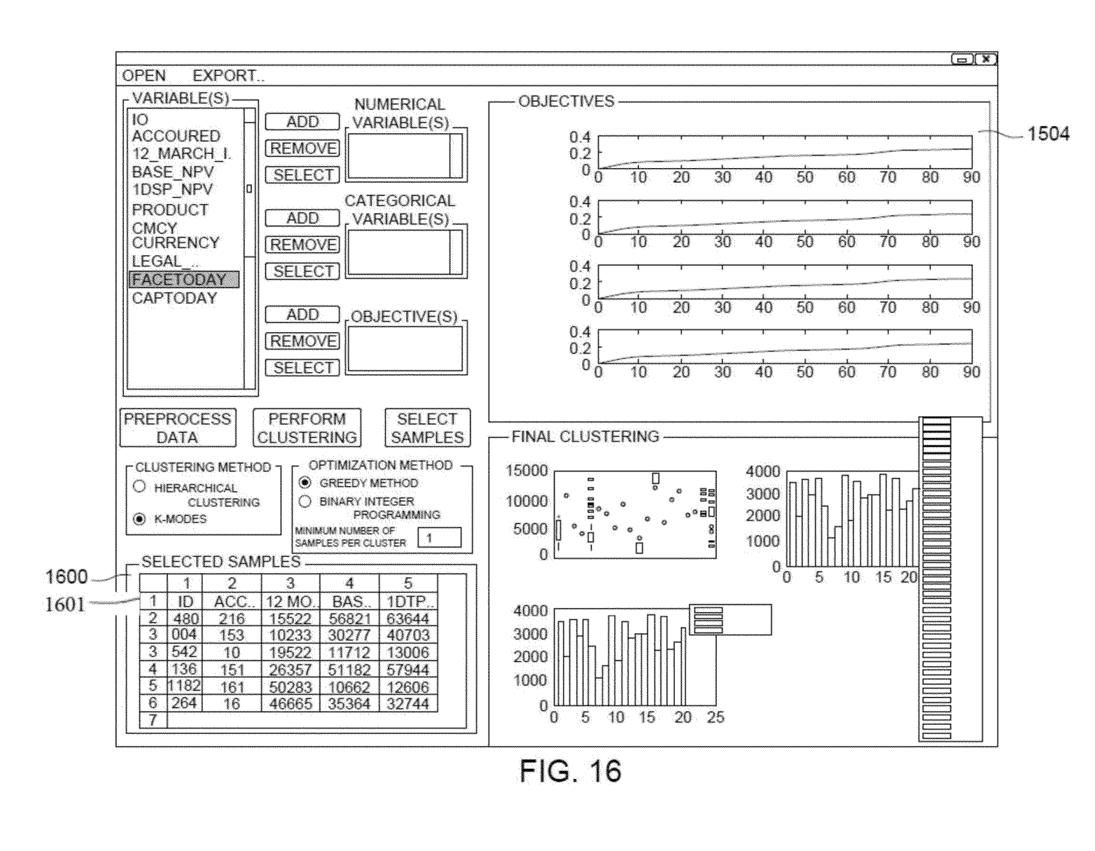

After the user confirms the number of iterations in the iteration dialog box 1502 by selecting the “OK” button 1510, in one or more embodiments, the selected samples 1601 (sub set of the original data set) are generated in S1420 and displayed in S1422, as illustrated in the selected samples window 1600 in FIG. 16. With the display of the selected samples 1601, the objectives chart window 1504 may display the tradeoff in selecting a particular number of samples (e.g., a workload) versus coverage of the objectives.

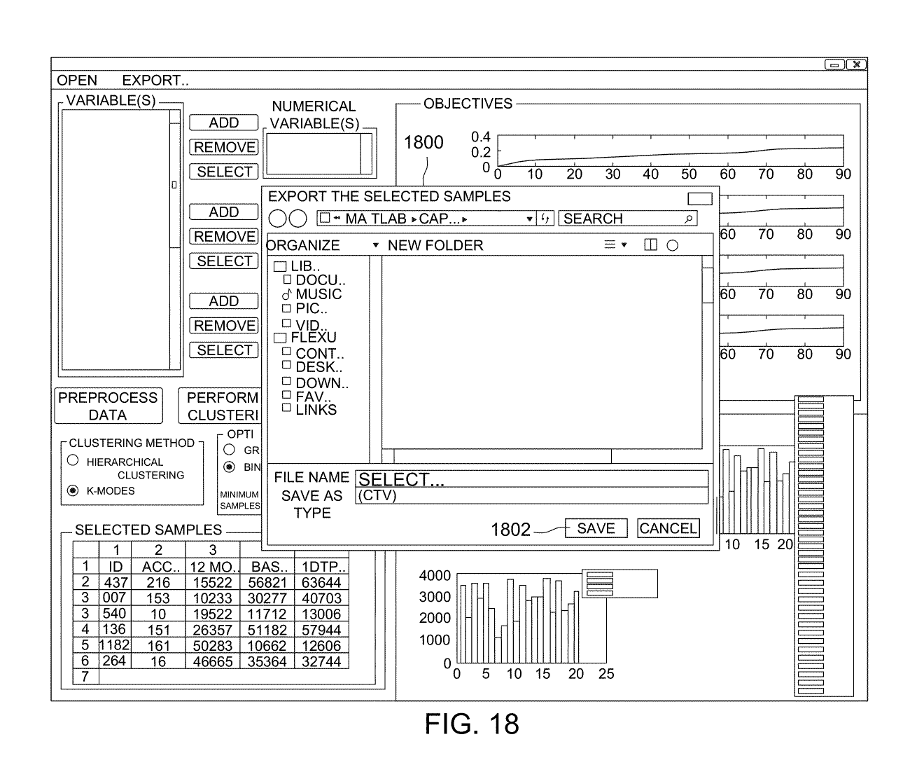

Then in S1424, the samples may be exported to a file by selecting the “export” menu 1508, which then provides the “Export the selected Samples” output dialog box 1800 (FIG. 18). The user may identify the name of the file in the dialog box 1800 and select the “save” button 1802 to save the data in a file. In one or more embodiments, the file may be a cvs file. In one or more embodiments, the default file name may be “selectedSample,” and the user may change the name of the file and then select the “save” button 1802 to save the samples in the specified file.

Returning to S1414, if the user selects the Binary Integer Programming Strategy, the process 1400 proceeds to S1426 and the strategy is applied. In one or more embodiments, when applying the Binary Integer Programming Strategy, for example, it is desirable to select the fewest samples to meet the exposure and risk constraints, such that:

$$Minimize \sum {x}_{i} = ( {x}_{i} = 0 or 1 )$$

$$Such that , \\ [ \begin{matrix}{b}_{1}^{′} \\ ⋮ \\ {b}_{M}^{′}\end{matrix} ] x \geq [ \begin{matrix}20 \% of objective 1 \\ ⋮ \\ 20 \% of objective M\end{matrix} ]$$

$$and \\ [ \begin{matrix}{c}_{1}^{′} - {c}_{2}^{′} \\ … \\ {c}_{1}^{′} - {c}_{k}^{′}\end{matrix} ] x = [ \begin{matrix}0 \\ … \\ 0\end{matrix} ] ,$$

where bⱼ(j=1, 2, . . . , M) is the column vector corresponding to the ith identified objective, M is the total number of objectives, cᵢ(i=1, 2, . . . k) is the binary vector with 1 indicating the inclusion of a sample in cluster i and k is the number of clusters

In one or more embodiments, another binary integer programming strategy may be used whereby it is desirable to select the fewest samples to meet the exposure and risk constraints, such that:

$$Minimize \sum {x}_{i} = ( {x}_{i} = 0 or 1 )$$

$$such that , \\ [ \begin{matrix}{b}_{1}^{′} \\ ⋮ \\ {b}_{M}^{′}\end{matrix} ] x \geq [ \begin{matrix}20 \% of objective 1 \\ ⋮ \\ 20 \% of objective M\end{matrix} ]$$

$$and \\ [ \begin{matrix}{c}_{1}^{′} \\ … \\ {c}_{k}^{′}\end{matrix} ] x \geq [ \begin{matrix}r \\ … \\ r\end{matrix} ] ,$$

where bⱼ(j=1, 2, . . . , M) is the column vector corresponding to the ith identified objective, M is the total number of objectives, k is the number of clusters, r is the minimum number of samples that should be selected from each cluster, and cᵢ is the binary vector with 1 indicating the inclusion of a sample in cluster i.

The second inequality may indicate that it is desirable to select at least r (user specified) samples from each cluster.

Then in S1428, a user enters a minimum number of samples to be selected from each cluster in a sample per cluster box 1702 (FIG. 17). In one or more embodiments, the default minimum number of samples to be selected from each cluster is one. The user may then select the “Select Samples” button 1500 (FIG. 15) to apply the strategy and generate selected samples in S1420. In one or more embodiments, the Binary Integer Programming Strategy may be implemented as a Matlab® function. In one or more embodiments, it may be desirable to have a sample size of 15K or less. The samples may be displayed in S1422. As shown in FIG. 17, for example, fourteen samples are selected for the Expre sub-portfolio as displayed in the selected samples window 1600, and at least one sample comes from each of the six clusters in this example.

In one or more embodiments, the user may adjust the target values of the objectives, or add and remove objectives. In one or more embodiments, the optimization module may be re-run if at least one objectives has changed. For example, in order to lower the target of the variable “DV01” to 10%, the user can first remove “DV01” from the objective variable window 608 by highlighting the variable and selecting the “remove” button 612, and then add “DV01” back to the objective variable window 608 but changing the objective target value to 0.1 when asked to enter the target with the input dialog box 700. After all objectives are reset, the user may select the “select” button 614, and use the “Preprocess data” button 706 to process the data. The user may not need to run the clustering module 112 again if there is no change to the numerical and categorical variables. The user then may select the optimization strategy, as described above with respect to S1414 and select “select samples” button 1500 to get the new set of samples.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, a clustering module and an optimization module. The method steps can then be carried out using the distinct software modules and/or sub-modules of the system, as described above, executing on one or more hardware processors 108 (FIG. 1). Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

1. A system comprising:
a communication device operative to communicate with a user to receive a data set including a plurality of samples at a clustering module;
a clustering module to receive the data set, store the data set, and calculate one or more clusters of samples using a clustering strategy;
an optimization module to receive and store the one or more clusters of samples from the clustering module and generate one or more samples from the one or more clusters of samples using an optimization strategy;
a memory for storing program instructions;
at least one sample selection platform processor, coupled to the memory, and in communication with the clustering module and the optimization module and operative to execute program instructions to:
calculate one or more clusters of samples based on the clustering strategy by executing the clustering module;
analyze the data associated with the one or more clusters received from the clustering module using the optimization strategy associated with the optimization module to automatically select one or more samples from the one or more clusters; and
provide one or more samples generated by the optimization module for replication in a validation model.

2. The system of claim 1, wherein the optimization module is operative to receive one or more objective variables.

3. The system of claim 2, wherein the optimization module is operative to receive a target value associated with each objective variable.

4. The system of claim 1, wherein the plurality of samples in the data set are associated with financial transactions.

5. The system of claim 1, wherein the at least one sample selection platform processor is operative to transmit the selected samples to a file.

6. The system of claim 1, wherein the data set includes at least one of numerical variables and categorical variables.

7. The system of claim 6, wherein the clustering module is operative to apply one of a hierarchical clustering strategy and a K-mode clustering strategy to data associated with the at least one of numerical and categorical variables.

8. The system of claim 1, wherein the optimization module is operative to apply one of a greedy optimization strategy and a binary integer programming optimization strategy to the one or more clusters prior to selection of the one or more samples.

9. A method comprising:
receiving a data set including a plurality of samples;
selecting clustering variables for input to a clustering module;
selecting optimization variables for input to an optimization module;
calculating, by execution of the clustering module, one or more clusters of samples based on a clustering strategy applied to data associated with the selected clustering variables;
analyzing, by execution of the optimization module, the data associated with the one or more clusters using an optimization strategy to automatically select one or more samples from the one or more clusters; and
providing one or more samples generated by the optimization module for replication in a validation model.

10. The method of claim 9, further comprising:
generating a histogram for each selected clustering variable.

11. The method of claim 9, further comprising:
determining whether the data includes missing values for the selected clustering variable prior to execution of the clustering module.

12. The method of claim 9, wherein the clustering variables are one of numerical and categorical variables.

13. The method of claim 12, further comprising:
converting one or more non-integer values associated with the categorical variables into integers.

14. The method of claim 9, wherein calculating one or more clusters of samples further comprises:
selecting one of a hierarchical clustering strategy and a K-mode clustering strategy.

15. The method of claim 9, wherein analyzing the data associated with one or more clusters further comprises:
selecting one of a greedy optimization strategy and a binary integer programming optimization strategy.

16. A non-transitory, computer-readable medium storing instructions that, when executed by a sample selection platform processor, cause the sample selection platform processor to perform a method associated with sample selection, the method comprising:
receiving a data set including a plurality of samples;
selecting clustering variables associated with the data set for input to a clustering module;
selecting optimization variables associated with the data set for input to an optimization module;
calculating, by execution of the clustering module, one or more clusters of samples based on a clustering strategy applied to data associated with the selected clustering variables;
analyzing, by execution of the optimization module, the data associated with the one or more clusters using an optimization strategy to automatically select one or more samples from the one or more clusters; and
providing one or more samples generated by the optimization module for replication in a validation model.

17. The medium of claim 16, wherein calculating one or more clusters of samples further comprises:
applying one of a K-mode clustering strategy and a hierarchical clustering strategy.

18. The medium of claim 16, further comprising:
generating a recommended number of clusters.

19. The medium of claim 16, wherein analyzing the data associated with the one or more clusters further comprises:
applying one of a greedy optimization strategy and a binary integer programming optimization strategy.

20. The medium of claim 19, wherein application of the greedy optimization strategy further comprises:
inputting a number of iterations.

21. The medium of claim 19, wherein application of the binary integer programming optimization strategy further comprises:
inputting a minimum number of samples per cluster.
